(19) United States
(12) Patent Application Publication
(10) Pub. No.: US 2015/0015357 A1
(43) Pub. Date: Jan. 15, 2015

(54) MULTILAYER INDUCTOR

(71) Applicant: SAMSUNG ELECTRO-MECHANICS CO., LTD., Suwon-si (KR)

(72) Inventor: Bong Sup LIM, Suwon-si (KR)

(73) Assignee: SAMSUNG ELECTRO-MECHANICS CO., LTD., Suwon-si (KR)

(21) Appl. No.: 14/072,685

(22) Filed: Nov. 5, 2013

(30) Foreign Application Priority Data
Jul. 9, 2013 (KR) 10-2013-0080407

(51) Int. Cl. H01F 27/28

(52) U.S. Cl. CPC H01F 27/2804
USPC 336/200

(57) ABSTRACT

Disclosed herein is a multilayer inductor including: a multilayered body formed by alternately multilayering magnetic sheets and internal electrodes and a pair of external terminals provided at both end portions of the multilayered body, the internal electrodes being interlayer-connected through a via to form a coil, wherein a ratio (Ts/Te) between a space Ts between internal electrodes of upper and lower layers and a thickness Te of a single internal electrode and a ratio (Fw/W) between an inner width Fw of the internal electrode and a width W of the multilayered body are determined according to parasitic capacitance C generated between the internal electrodes of upper and lower layers, parasitic capacitance C generated between the internal electrodes and the external terminals, inductance L proportional to the number of layers of the internal electrodes, and inductance L proportional to an internal sectional area of the coil.

### CROSS REFERENCE(S) TO RELATED APPLICATIONS

This application claims the benefit under 35 U.S.C. Section 119 of Korean Patent Application Serial No. 10-2013-0080407, entitled “Multilayer Inductor” filed on Jul. 9, 2013, which is hereby incorporated by reference in its entirety into this application.

### BACKGROUND OF THE INVENTION

1. Technical Field

The present invention relates to a multilayer inductor, and more particularly, to a disposition structure of internal electrodes included in a multilayer inductor.

2. Description of the Related Art

An inductor, one of important passive elements constituting an electronic circuit, along with a resistor and a capacitor, is used in a power source circuit such as a DC-DC converter in an electronic device or extensively used as a component for canceling noise or constituting an LC resonance circuit.

Meanwhile, in line with the development of IT technologies, electronic devices have been increasingly reduced in size and thickness, and market demands for smaller and thinner devices have also increased. Thus, products of inductors having a thin film structure have been developed, and a multilayer inductor, as one of such products, have been proposed.

However, such a multilayer inductor is degraded in performance as a chip size is reduced, and in particular, a degradation of a quality factor (hereinafter, referred to as ‘Q characteristics’) as an indicator indicating performance of a product cannot be avoided.

Namely, a multilayer inductor having a general structure includes a multilayered body formed by multilayering a plurality of magnetic sheets having an internal electrode of a coil pattern formed on one surface thereof, and a pair of external terminals provided at both end portions of the multilayered body. As the chip is reduced in size, a space between the layers of the internal electrodes and a space between the internal electrodes and the external terminals is narrowed to increase parasitic capacitance (C) generated between internal electrodes of upper and lower layers and between the internal electrodes and the external terminals, degrading Q characteristics.

Also, in order to implement high inductance, a coil pattern is designed to be lengthened; however, a resistance value, i.e., AC resistance (Rs), generated when AC power is applied to an inductor is increased to lead to rapid magnetic saturation of a magnetic body, resulting in a rapid degradation in inductance (degradation of DC-Bias characteristics).

Thus, in order to prevent a rapid degradation in the inductance (L) and constantly maintain Q characteristics at a predetermined value or higher, a patent document (Korean Patent Laid-Open Publication No. 10-2010-0127878) discloses a method for increasing a magnetic saturation level by replacing some magnetic layer sheet with non-magnetic sheets.

However, in the case of replacing some magnetic layer sheets with non-magnetic sheets in the patent document, the number of layers of the internal electrodes is reduced as much, lowering an overall value of the inductance (L), and thus, degrading Q characteristics.

### RELATED ART DOCUMENT

(Patent Document 1): Korean Patent Laid-Open Publication No. 10-2010-0127878

### SUMMARY OF THE INVENTION

An object of the present invention is to provide a multilayer inductor capable of maximizing Q characteristics by optimizing a space Ts between internal electrodes of upper and lower layers, a thickness (Te) of the internal electrodes, an inner width Fw of the internal electrodes, a width W of a multilayered body, and the like.

According to an embodiment of the present invention, there is provided a multilayer inductor including: a multilayered body formed by alternately multilayering magnetic sheets and internal electrodes in a coil pattern; and a pair of external terminals provided at both end portions of the multilayered body, wherein a space Ts between internal electrodes of upper and lower layers is greater than a thickness Te of a single internal electrode.

A ratio (Ts/Te) between the space Ts between the internal electrodes of upper and lower layers and the thickness Te of the internal electrode may range from 2.0 to 3.0.

A ratio (Fw/W) between an inner width Fw of the internal electrode and a width W of the multilayered body may range from 0.6 to 0.7.

A distance Bc between the internal electrode positioned in the lowermost layer and a lower surface of the multilayered body may be greater than a distance Tc between the internal electrode positioned in the uppermost layer and an upper surface of the multilayered body.

A ratio (Tc/Bc) between the distance Tc between the internal electrode positioned in the uppermost layer and the upper surface of the multilayered body and the distance Bc between the internal electrode positioned in the lowermost layer and the lower surface of the multilayered body may range from 0.1 to 0.9.

According to an embodiment of the present invention, there is also provided a multilayer inductor including: a multilayered body formed by alternately multilayering magnetic sheets and internal electrodes and a pair of external terminals provided at both end portions of the multilayered body, the internal electrodes being interlayer-connected through a via to form a coil, wherein a ratio (Ts/Te) between a space Ts between internal electrodes of upper and lower layers and a thickness Te of a single internal electrode ranges from 2.0 to 3.0 and a ratio (Fw/W) between an inner width Fw of the internal electrode and a width W of the multilayered body ranges from 0.6 to 0.7.

A ratio (Tc/Bc) between a distance Tc between the internal electrode positioned in the uppermost layer and an upper surface of the multilayered body and a distance Bc between the internal electrode positioned in the lowermost layer and a lower surface of the multilayered body may range from 0.1 to 0.9.

### BRIEF DESCRIPTION OF THE DRAWINGS

FIG. 1 is an external perspective view of a multilayer inductor according to an embodiment of the present invention;

FIG. 2 is a cross-sectional view taken along line I-I′ in FIG. 1; and

FIGS. 3 through 5 are graphs showing inductance (L), AC resistance (Rs), and Q characteristics over frequency.

### DESCRIPTION OF THE PREFERRED EMBODIMENTS

Hereinafter, exemplary embodiments will be described in detail with reference to the accompanying drawings so that they can be easily practiced by those skilled in the art to which the present invention pertains.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

Therefore, the configurations described in the embodiments and drawings of the present invention are merely most preferable embodiments but do not represent all of the technical spirit of the present invention. Thus, the present invention should be construed as including all the changes, equivalents, and substitutions included in the spirit and scope of the present invention at the time of filing this application.

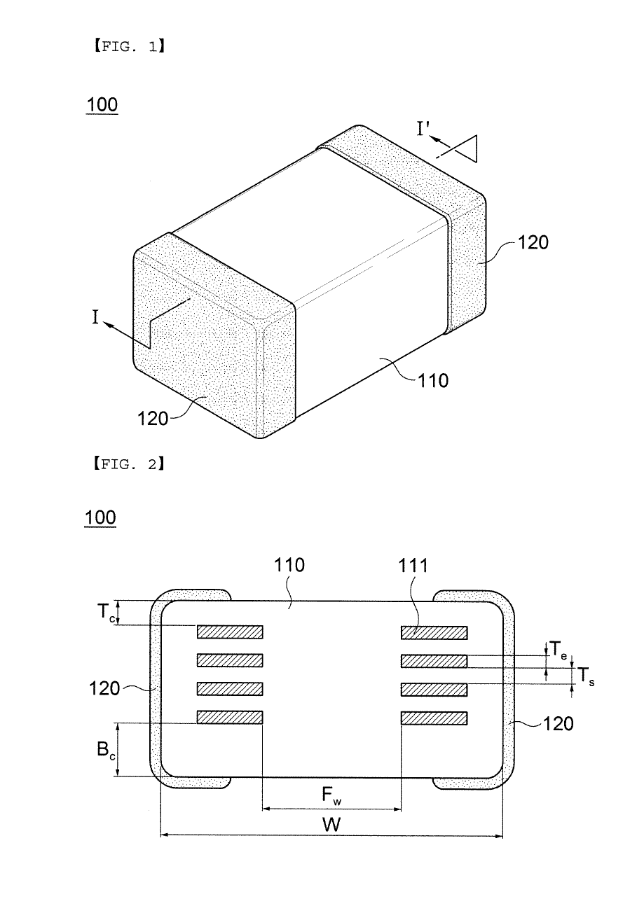

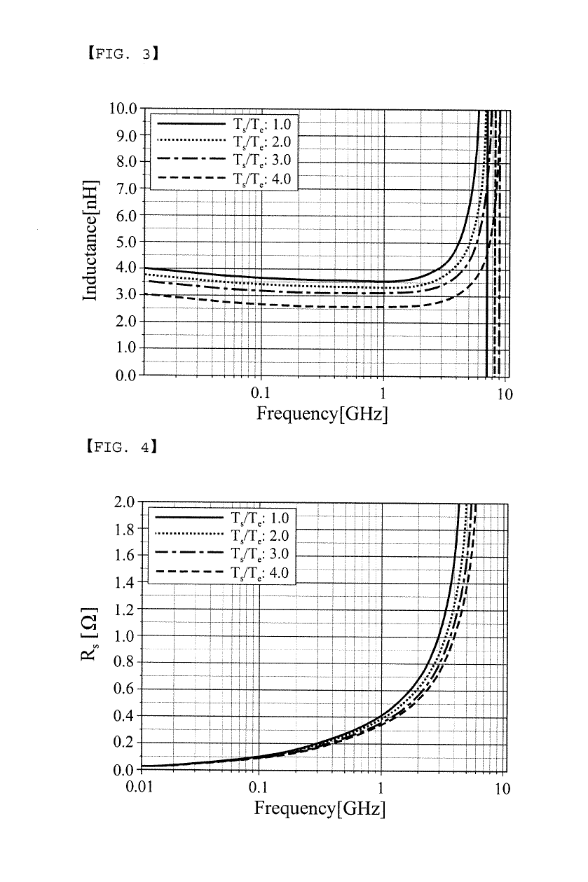

FIG. 1 is an external perspective view of a multilayer inductor according to an embodiment of the present invention, and FIG. 2 is a cross-sectional view taken along line I-I′ in FIG. 1. In the drawings, the components are not illustrated according to the scale but dimensions of some elements may be exaggerated to help understand the present invention.

Referring to FIGS. 1 and 2, a multilayer inductor 100 may include a multilayered body 110 and a pair of external terminals 120 provided at both end portions of the multilayered body 110.

Here, the multilayered body 110 is formed by multilayering a plurality of magnetic sheets made of Ni—Zn—Cu-based ferrite, and the like, and subsequently pressurizing and sintering them, and the adjacent magnetic sheets are integrated such that boundary therebetween may not be readily apparent.

A coil wound spirally is provided within the multilayered body 110. The coil may be formed as internal electrodes 111 formed on one surface of each of the magnetic sheets are connected. Namely, an internal electrode 111, dividing a winding of the coil, is formed on one surface of each magnetic sheet, and internal electrodes 111 of the respective layers are interlayer-connected to an adjacent internal electrode 111 through a via (not shown) penetrating through the magnetic sheets, forming a coil having a predetermined internal sectional area.

Each internal electrode 111 may be formed by printing a metal paste, e.g., at least one type of metal selected from the group consisting of, for example, Ni, Al, Fe, Cu, Ti, Cr, Au, Ag, Pd, and Pt, or a metal compound thereof on each magnetic sheet through a screen printing method.

When the internal electrode 111 is printed, a corner portion thereof may be bent at a right angle or may be bent to be curved. In the case in which the corner portion of the internal electrode 111 is bent at a right angle, an internal sectional area of the coil may be increased at the maximum, implementing high capacity inductance. Meanwhile, in the case in which a corner portion of the internal electrode 111 is bent to be curved, current flowability can be enhanced to improve DC resistance characteristics Rdc.

Also, in order to prevent a degradation of Q characteristics due to parasitic capacitance C increased according to a reduction in size of devices, specifically, parasitic capacitance C generated between internal electrodes 111 of upper and lower layers, preferably, a space Ts between the internal electrodes 111 of upper and lower layers is increased as much as possible.

Thus, the multilayer inductor 100 according to an embodiment of the present invention, the space Ts between the internal electrodes 111 of upper and lower layers is greater than a thickness Te of the internal electrode 111. Namely, parasitic capacitance C is increased as a distance between adjacent conductors is reduced, so, in an embodiment of the present invention, the magnetic sheet with the internal electrode 111 printed thereon is formed to be thick to increase the space Ts between the internal electrodes 111 of the upper and lower layers such that it is greater than the thickness Te of the internal electrode 111.

However, a chip size is limited, so if the magnetic sheet is too thick, the number of layers of the internal electrodes 111 is also reduced as much, that is, lowering inductance L to result in a degradation of Q characteristics of the multilayer inductor 100.

Thus, in the multilayer inductor 100 according to an embodiment of the present invention, preferably, a ratio (Ts/Te) between the space Ts between the internal electrodes 111 of upper and lower layers and the thickness Te of the internal electrode 111 is appropriately set in consideration of parasitic capacitance C generated between the internal electrodes 111 of upper and lower layers and inductance L proportional to the number of layers of the internal electrodes 111.

Meanwhile, the Q characteristics of the inductor are affected by a resistance value Rs (hereinafter, referred to as AC resistance) generated when AC power is applied to the inductor according to Equation 1 below. Thus, preferably, the AC resistance Rs is taken into consideration in determining the ratio (Ts/Te) between the space Ts between the internal electrodes 111 of upper and lower layers and the thickness Te of the internal electrode 111.

$$Q = \frac{2 π fL}{{R}_{s}} \qquad [ Equation 1 ]$$

The Q characteristics are enhanced as the value of the AC resistance Rs is reduced according to Equation 1. The AC resistance Rs is lowered as the space Ts between the internal electrodes 111 of upper and lower layers is increased based on a proximity effect. However, if the space Ts between the internal electrodes 111 of upper and lower layers is too large, the number of layers of the internal electrodes 111 is reduced to degrade inductance L.

Thus, preferably, an optimal range regarding the ratio (Ts/Te) between the space Ts between the internal electrodes 111 of upper and lower layers and the thickness Te of the internal electrode 111 is determined in consideration of a trade-off relationship between the parasitic capacitance C and the inductance L and between the AC resistance Rs and the inductance L, and the optimal range may be derived through the following measurement values.

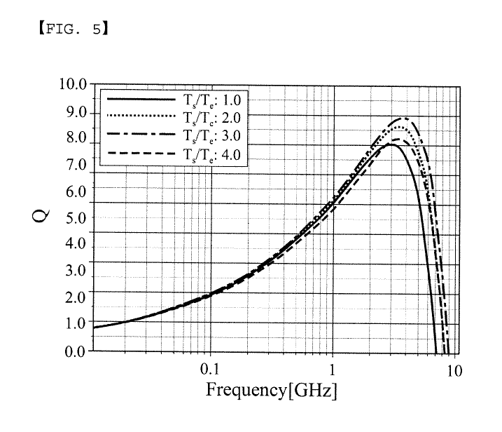

FIGS. 3 through 5 are graphs of inductance L, AC resistance Rs, and Q characteristics over frequency when the space Ts between the internal electrodes 111 of upper and lower layers was varied at 20 μm, 40 μm, 60 μm, and 80 μm, while the thickness Te of the internal electrode 111 is fixed to 20 μm in an inductor device having a 0402 size (0.4 mm (length)×0.2 mm (width)×0.2 mm (height)), namely, when the ratio (Ts/Te) between the space Ts between the internal electrodes 111 of upper and lower layers and the thickness Te of the internal electrode 111 was varied to 1.0, 2.0, 3.0, and 4.0. Table 1 below shows respective measurement values in 100 MHz and 2.4 GHz.

TABLE 1

| | Classification | | | | | | | | | | | |
|---|---|---|---|---|---|---|---|---|---|---|---|---|
| | L[nH] | | L variation | | Q | | Q variation | | R_{s [mΩ]} | | Rₛ variation | |
| | Frequency | | | | | | | | | | | |
| | 100 | 2.4 | 100 | 2.4 | 100 | 2.4 | 100 | 2.4 | 100 | 2.4 | 100 | 2.4 |
| | MHz | GHz | MHz | GHz | MHz | GHz | MHz | GHz | MHz | GHz | MHz | GHz |
| T_{s/}T_{e:} 1.0 | 3.66 | 3.87 | — | — | 20 | 69.01 | — | — | 115 | 846 | — | — |
| T_{s/}T_{e:} 2.0 | 3.41 | 3.51 | −5.83 | −8.3 | 20 | 72.24 | 1 | 5.68 | 105 | 734 | −7.7 | −12.2 |
| T_{s/}T_{e:} 3.0 | 3.21 | 3.27 | −11.3 | −14.5 | 20 | 73.59 | 1 | 7.637 | 100 | 671 | −12 | −19.7 |
| T_{s/}T_{e:} 4.0 | 2.71 | 2.7 | −25 | −29.2 | 19.3 | 68.72 | −2.5 | 0.58 | 97 | 639 | −14.7 | −23.5 |

As can be seen in FIGS. 3 through 5 and Table 1, the Q characteristics were not greatly different in low frequency bands such as 100 MHz, but exceeded 70 when the ratio (Ts/Te) between the space Ts between the internal electrodes 111 of upper and lower layers and the thickness Te of the internal electrode 111 were 2.0 and 3.0 toward higher frequency bands such as 2.4 GHz.

Thus, the ratio (Ts/Te) between the space Ts between the internal electrodes 111 of upper and lower layers and the thickness Te of the internal electrode 111 may have an optimal value within the range from 2.0 to 3.0. However, the numeral value range was derived on the basis of the measurement results of the inductor device having the 0402 size, so it would be obvious for a person skilled in the art that the numerical value range may be changed according to a size of an inductor device.

Meanwhile, in order to prevent a degradation of the Q characteristics due to parasitic capacitance C generated between the internal electrodes 111 and the external terminals 120 in the multilayer inductor 100, the internal electrodes 111 may be disposed to be separated from the external terminals 120 as far as possible. In this case, however, if the internal electrodes 111 are separated too far from the external terminals 120, an internal sectional area of the coil may be accordingly narrowed, degrading inductance L.

According to Equation 1, the Q characteristics of the inductor are also affected by the AC resistance Rs. Since the AC resistance Rs is proportional to a length of the coil, the internal electrodes 111 may be disposed to be separated from the external terminals 120 as far as possible to reduce the length of the coil, thus lowering the AC resistance Rs. In this case, however, if the internal electrodes 111 are separated too far from the external terminals 120, an internal sectional area of the coil may be accordingly reduced, degrading inductance L.

Thus, preferably, an optimal range regarding a ratio (Fw/W) between an inner width Fw of the internal electrode 111 and a width W of the multilayered body 110 is determined in consideration of the trade-off relationship between the parasitic capacitance C and the inductance L and between the AC resistance Rs and the inductance L.

Table 2 below shows measurement of inductance L, AC resistance Rs, and Q characteristics according to the number of turns of the coil when the ratio (Fw/W) between the inner width Fw of the internal electrode 111 and the width W of the multilayered body 110 was 0.5, 0.6, 0.7, and 0.8.

TABLE 2

| | Classification | | | | | | | | | | | |
|---|---|---|---|---|---|---|---|---|---|---|---|---|
| | F_{w/}W: 0.5 | | | F_{w/}W: 0.6 | | | F_{w/}W: 0.7 | | | F_{w/}W: 0.8 | | |
| | L | Q | Rₛ | L | Q | Rₛ | L | Q | Rₛ | L | Q | Rₛ |
| Measurement | 100 | 100 | 1 | 100 | 100 | 1 | 100 | 100 | 1 | 100 | 100 | 1 |
| items | MHz | MHz | MHz | MHz | MHz | MHz | MHz | MHz | MHz | MHz | MHz | MHz |
| 1 Turns | 1.53 | 20.38 | 0.013 | 2.03 | 19.93 | 0.017 | 2.23 | 20.08 | 0.019 | 3.35 | 21.17 | 0.039 |
| 2 Turns | 2.28 | 18.55 | 0.021 | 3.41 | 20.2 | 0.028 | 3.89 | 20.92 | 0.032 | 5.66 | 22.36 | 0.049 |
| 3 Turns | 3.12 | 17.95 | 0.028 | 5.01 | 20.94 | 0.039 | 5.85 | 21.96 | 0.044 | 8.38 | 23.28 | 0.067 |
| 4 Turns | 4.01 | 17.61 | 0.036 | 6.72 | 21.48 | 0.051 | 7.99 | 22.74 | 0.057 | 11.33 | 24.9 | 0.083 |
| 5 Turns | 4.91 | 17.36 | 0.044 | 8.55 | 22.06 | 0.062 | 10.2 | 23.43 | 0.069 | 14.47 | 25.21 | 0.094 |

As can be seen in Table 2, as the ratio (Fw/W) between the inner width Fw of the internal electrode 111 and the width W of the multilayered body 110 was increased, both values of the inductance L and the AC resistance Rs were increased, and in inductance L equal to or greater than a requested predetermined value, e.g., in inductance L equal to or greater than 2, optimal values of Q characteristics were obtained when the ratio (Fw/W) between the inner width Fw of the internal electrode 111 and the width W of the multilayered body 110 was 0.6 and 0.7

On the basis of the foregoing experiment, in the multilayer inductor 100 according to an embodiment of the present invention, the ratio (Ts/Te) between the space Ts between the internal electrodes 111 of upper and lower layers and the thickness Te of the internal electrode 111 may be determined within a range from 2.0 to 3.0 and the ratio (Fw/W) between the inner width Fw of the internal electrode 111 and the width W of the multilayered body 110 may be determined within the range from 0.6 to 0.7.

Meanwhile, the multilayer inductor 100 according to an embodiment of the present invention is mounted in a thickness direction by soldering the external terminals 120 on a land formed on a printed board. In this case, if a distance between the internal electrode 111 to the printed board is short due to a reduction of a chip in size, magnetic flux may be interlinked with a circuit pattern of the printed board at one point to degrade the Q characteristics.

In consideration of this, in an embodiment of the present invention, the internal electrodes 111 are disposed such that a distance Bc between the internal electrode positioned in the lowermost layer and a lower surface of the multilayered body is greater than a distance Tc between the internal electrode positioned in the uppermost layer and an upper surface of the multilayered body.

In this case, however, if the distance Bc between the internal electrode positioned in the lowermost layer and a lower surface of the multilayered body is too long within a limited chip size, the internal electrode 111 positioned in the uppermost layer may be disposed to be close to the upper surface of the multilayered body 110, increasing a possibility that the internal electrode 111 of the uppermost layer is exposed to the outside during the manufacturing process.

Thus, preferably, a ratio (Tc/Bc) between the distance Tc between the internal electrode 111 positioned in the uppermost layer and the upper surface of the multilayered body 110 and the distance Bc between the internal electrode 111 positioned in the lowermost layer and the lower surface of the multilayered body 110 is determined within the range from 0.1 to 0.9 according to measurement values of Table 3 below. Of course, since the numerical value range was derived on the basis of the measurement results of the inductor device having the 0402 size, it would be obvious for a person skilled in the art that the numerical value range is changed according to a size of an inductor device.

TABLE 3

Q

| T_{c}/B_{c} | 100 MHz | 500 MHz | 1000 MHz | 2000 MHz |
|---|---|---|---|---|
| 0.1 | 4.646 | 11.26 | 16.24 | 24.1 |
| 0.2 | 4.713 | 11.13 | 16.06 | 23.86 |
| 0.3 | 4.38 | 10.85 | 15.64 | 23.4 |
| 0.4 | 4.876 | 11.67 | 16.42 | 24.29 |
| 0.5 | 4.524 | 10.74 | 15.39 | 22.73 |
| 0.6 | 4.332 | 10.94 | 15.83 | 23.51 |
| 0.7 | 4.44 | 10.85 | 15.72 | 23.47 |
| 0.8 | 4.77 | 10.36 | 15.19 | 22.89 |
| 0.9 | 4.876 | 11.67 | 16.42 | 24.29 |
| 1.0 | 4.524 | 10.74 | 15.39 | 22.73 |
| 1.1 | 4.332 | 10.94 | 15.83 | 23.51 |
| 1.2 | 4.44 | 10.85 | 15.72 | 23.47 |
| 1.3 | 4.363 | 10.921 | 15.841 | 23.591 |
| 1.4 | 4.732 | 11.271 | 16.071 | 23.791 |
| 1.5 | 4.667 | 11.281 | 16.261 | 24.121 |
| 1.6 | 1.594 | 8.011 | 12.941 | 20.741 |

According to the embodiments of the present invention, in the multilayer inductor, maximum Q characteristics can be implemented by optimizing the space Ts between the internal electrodes of upper and lower layers, the thickness Te of the internal electrode, the inner width Fw of the internal electrode, the width W of the multilayered body, and the like, without using a non-magnetic sheet.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A multilayer inductor comprising:
a multilayered body formed by alternately multilayering magnetic sheets and internal electrodes in a coil pattern; and
a pair of external terminals provided at both end portions of the multilayered body,
wherein a space Ts between internal electrodes of upper and lower layers is greater than a thickness Te of a single internal electrode.

2. The multilayer inductor according to claim 1, wherein a ratio (Ts/Te) between the space Ts between the internal electrodes of upper and lower layers and the thickness Te of the internal electrode ranges from 2.0 to 3.0.

3. The multilayer inductor according to claim 1, wherein a ratio (Fw/W) between an inner width Fw of the internal electrode and a width W of the multilayered body ranges from 0.6 to 0.7.

4. The multilayer inductor according to claim 1, wherein a distance Bc between the internal electrode positioned in the lowermost layer and a lower surface of the multilayered body is greater than a distance Tc between the internal electrode positioned in the uppermost layer and an upper surface of the multilayered body.

5. The multilayer inductor according to claim 4, wherein a ratio (Tc/Bc) between the distance Tc between the internal electrode positioned in the uppermost layer and the upper surface of the multilayered body and the distance Bc between the internal electrode positioned in the lowermost layer and the lower surface of the multilayered body ranges from 0.1 to 0.9.

6. A multilayer inductor including a multilayered body formed by alternately multilayering magnetic sheets and internal electrodes and a pair of external terminals provided at both end portions of the multilayered body, the internal electrodes being interlayer-connected through a via to form a coil,
wherein a ratio (Ts/Te) between a space Ts between internal electrodes of upper and lower layers and a thickness Te of a single internal electrode ranges from 2.0 to 3.0 and a ratio (Fw/W) between an inner width Fw of the internal electrode and a width W of the multilayered body ranges from 0.6 to 0.7.

7. The multilayer inductor according to claim 6, wherein a ratio (Tc/Bc) between a distance Tc between the internal electrode positioned in the uppermost layer and an upper surface of the multilayered body and a distance Bc between the internal electrode positioned in the lowermost layer and a lower surface of the multilayered body ranges from 0.1 to 0.9.
